(19) United States
(12) Patent Application Publication
(10) Pub. No.: US 2010/0259373 A1
(43) Pub. Date: Oct. 14, 2010

(54) Storage device of car event data recorder

(76) Inventor: Ching-Shan Chang, Hsin-Chuang City (TW)

Correspondence Address: Muncy, Geissler, Olds & Lowe, PLLC, 4000 Legato Road, Suite 310, FAIRFAX, VA, 22033, US

(21) Appl. No.: 11/976,725

(22) Filed: Oct. 26, 2007

(30) Foreign Application Priority Data
Aug. 21, 2007 (TW) 096130946

(51) Int. Cl. B60Q 1/00; H04N 7/26

(52) U.S. Cl. 340/438; 386/124; 386/E05.001

(57) ABSTRACT

A storage device of car event data recorders is revealed. The storage device of car event data recorders includes at least two sets of memory or at least one memory set with at least two memory areas. The first memory module (or area) is used to record real time audio/video data with continuous attributes while the second memory module (or area) is for retrieving and recording audio/video data at the time of the accident and/or pre-alarm audio/video data before the accident and/or post-alarm audio/video data after the accident. The interval before or after the accident may be a few decades of seconds. Thereby the storage device of car event data recorders can perform long-term safety control operations and completely record real time audio/video data during, before and after each event. Therefore, certain audio/video data is stored for long-term preservation and checked. Thus the efficiency of the storage device of car event data recorders is improved.

### BACKGROUND OF THE INVENTION

The present invention relates to a storage device of a car event data recorder, especially to a storage device of a car event data recorder with at least two memory modules or areas; the first memory module (or area) is used to record real-time audio/video data and the second memory module (or area) is used to retrieve and record online real-time and/or pre-alarm, and/or post-alarm duration audio/video data of every accidental event in different time intervals from the digital audio/video data of the first memory module.

Due to various requirements of users, different accessories are disposed on vehicles. Among the accessories, the GPS (global positioning system) or car security systems are the most popular ones. As to car security systems, generally a video recorder and player (or storage device) such as a DVR (digital video recorder) or other related device is connected with various monitoring devices such as small image sensors or audio sensor (minimicrophones), back-view mirror display systems, mobile displays, speakers, remote controllers and GPS receivers so as to ensure driving safety. With reference to TW Pat. No. 1257353, TW Pat. No. 1273052, US2007/0080826A1, US2007/0153085A1, CN101015018A, CN1988655A, CN101001357, and CN101001358A, a DVR basically includes a plurality of memory (storage media) for recording dynamic video and/or audio data. The data detected by the monitoring system is saved in real-time recording into the data storage unit in digital formats. A conventional analog recorder and player are replaced by a digital video recorder and player. The digital data can easily be stored and searched in real-time recording. Moreover, the cost and space of storage units are saved. A DVR is disposed with a hard disk and a video/audio capture card that saves digital video/audio data from image or sound sensors (mini-microphones) arranged in or on surfaces of the cars into the hard disk Real time image or sound is captured and is sent by an image or sound sensor to the DVR to be saved and time-recorded. The hard disc space is selectable according to users' requirements. For example, in regard to a security system in a place or a building, the hard disc can record images for about 400 to 720 hours if a 30 GB hard disc is used to record images in dynamic formats. As to a car security system, a small size hard disk is used as a storage unit to save space, besides being easy to install and saving cost. A lot of image data in the hard disc can be copied to other storage media such as discs for convenience of filing or managing. Due to the development of compression techniques of digital images and high compression ratios, the digital recording is suitable for long-term and continuous recording.

However, due to restrictions of interior space, a car DVR is disposed with a memory set (storage media) for recording real time or digital audio/video data with continuous attributes. In general, the recording volume of the memory set is limited so that the memory set can only store real time audio/video data of a certain time interval such as one day or several days. After recording during a certain period of time the memory set is full, and the previous data is directly overwritten by new real time audio/video data from the starting point. That means the previous recorded audio/video data is replaced by online real time audio/video data. Once the previous recorded audio/video data is backed up, it will be completely lost. Once digital audio/video data of an important accidental event is included in the previous recorded audio/video data, the event data is also overwritten by the following new audio/video data. Thus the safety control effect and efficiency of the automobile DVR are reduced.

The problems mentioned above can be solved by increasing the volume of the memory set to extend the recording time. However, increasing the memory volume as well as the addition of a memory of a high capacity is not feasible due to the space restriction of the car DVR. Moreover, the cost is also increased. If the recording mode is changed from real time recording to non real time recording such as intermittent recording, it leads to negative effects in the monitoring quality and efficiency of a car DVR or an automobile security system.

### SUMMARY OF THE INVENTION

Therefore it is a primary object of the present invention to provide a storage device of car event data recorders that includes at least two memory modules or is disposed with one memory module with two memory areas. The first memory module (or memory area) is for recording real time digital audio/video data with continuous attributes while the second memory module (or memory area) is used to record digital audio/video data at the time vehicle-related events occur. Moreover, a storage mechanism between the first memory module and the second memory module enables the second memory module (or memory area) to automatically record and retrieve audio/video data at the time an accidental event occurs. Thus the storage device of car event data recorders can perform long-term monitoring and completely record real time audio/video data of each event. Therefore, the effect and efficiency of the storage devices of car event data recorders are improved.

It is another object of the present invention that the second memory module (or memory area) can further retrieve and record pre-alarm audio/video data before the accident and/or post-alarm audio/video data after the accident. The time interval of the pre-alarm or the post-alarm audio/video data can be set or adjusted into a preset value in advance. The interval may be a few decades of seconds before and after the accident. Thereby the audio/video data of an event recorded in the second memory module (or memory area) is more complete. Therefore the efficiency of the storage device of car event data recorders is enhanced.

### BRIEF DESCRIPTION OF THE DRAWINGS

FIG. 1 is a block diagram of an embodiment according to the present invention being applied to a car safety system;

FIG. 2 is a block diagram showing two memory modules and the storage mechanism of an embodiment according to the present invention;

FIG. 3 is a schematic drawing showing the use status of the two memory modules and storage mechanism of the embodiment in FIG. 2;

FIG. 4 is a schematic drawing showing the use status of the two memory modules and storage mechanism of another embodiment according to the present invention;

FIG. 5 is a is a block diagram showing one memory module with two memory areas and the storage mechanism of an embodiment according to the present invention;

FIG. 6 is a schematic drawing showing the use status of the two memory areas and the storage mechanism of the embodiment in FIG. 5;

FIG. 7 is a schematic drawing showing the use status of the two memory areas and the storage mechanism of another embodiment according to the present invention.

### DETAILED DESCRIPTION OF THE PREFERRED EMBODIMENT

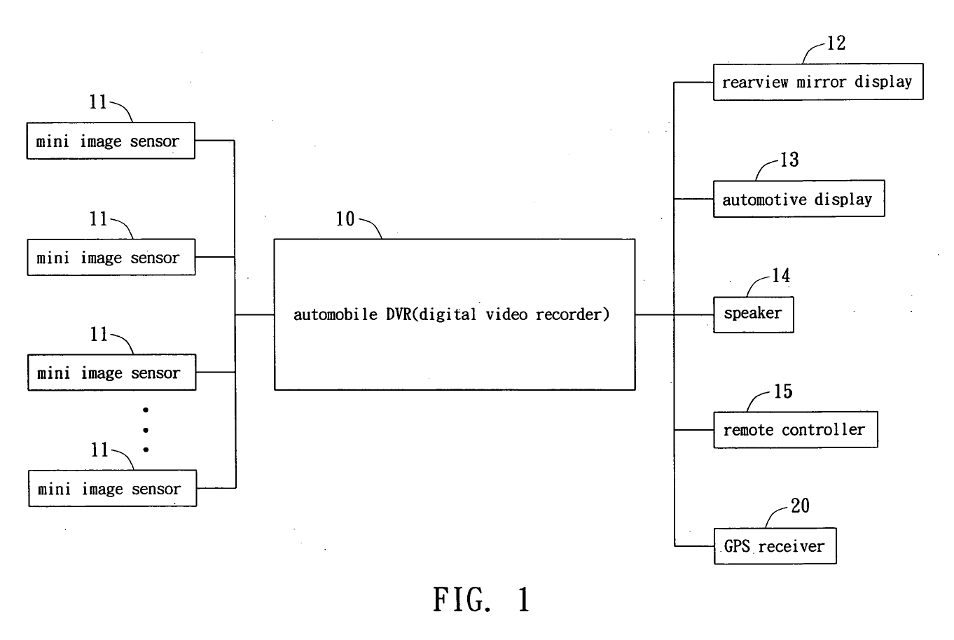

Referring to FIG. 1, an embodiment of the present invention is applied to an automobile security system. A storage device of car event data recorders has similar functions with an automobile DVR (digital video recorder) 10 and is able to connect with various kinds of related monitor devices, such as a mini image sensor 11 or a sound sensor (like a mini microphone), a rearview mirror display 12, an automotive display 13, a speaker 14, a remote controller 15 and a GPS receiver 20. The mini image sensor 11 is a CMOS (Complementary Metal-Oxide-Semiconductor) or CCD (Charge Coupled Device) audio/video camera that is installed in the front, rear, or both sides of the car to catch dynamic real time audio/video data and transmit the digital data to the automobile DVR 10 for data storage and time-recording of the digital data. The rearview mirror display 12 and the automotive display 13 are used to display the data received by the mini image sensor 11 as well as the GPS receiver 20 and then provide drivers with the current dynamic messages by sounding an alarm or reporting traffic conditions from the speaker 14. Moreover, the GPS receiver can display the current travel position and related messages onto a display of the GPS receiver 20, or transmit the data to the storage device of the DVR 10 for the driver's reference.

### First Embodiment

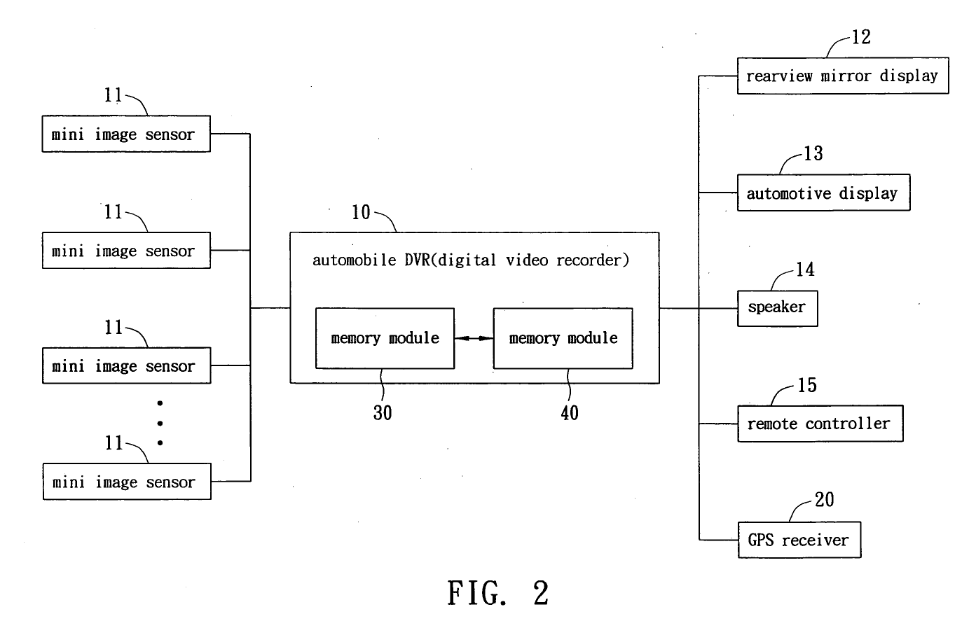

Referring to FIG. 2, an automobile DVR as an embodiment of an event data recorder of the present invention is disclosed. The automobile DVR 10 includes at least a first memory module 30 and a second memory module 40. The first memory module 30 is used to record real time digital audio/video data with continuous attributes, and can be rewritten after recording during a certain interval of time until the first memory module 30 is full. That means when the first memory module 30 is full of real time digital audio/video data with continuous attributes, the first memory module 30 will then automatically rewrite the previous data commencing from the beginning of the first memory module 30 itself by recording new digital audio/video data with continuous attributes. Thus the previous recorded audio-video data is replaced by new online real-time data. Meanwhile the second memory module 40, which is used to record the online real-time audio-video data of accidental events when any accidents occur, is connected with the first memory module 30 to form a storage mechanism which automatically triggers the recording function of the second memory module 40 to record the digital audio/video data of accidental events from the first memory module 30 at the time of any accidental events. Thereby the event data recorder (the automobile DVR) 10 processes a long term security control by means of the first memory module 30 while by the second memory module 40, the event data recorder (the automobile DVR) 10 records audio/video data of what the vehicle is doing before, during and after the accident, the entire unusual process of accidental events. Therefore the efficiency of the Event data recorders, the DVR 10, is improved.

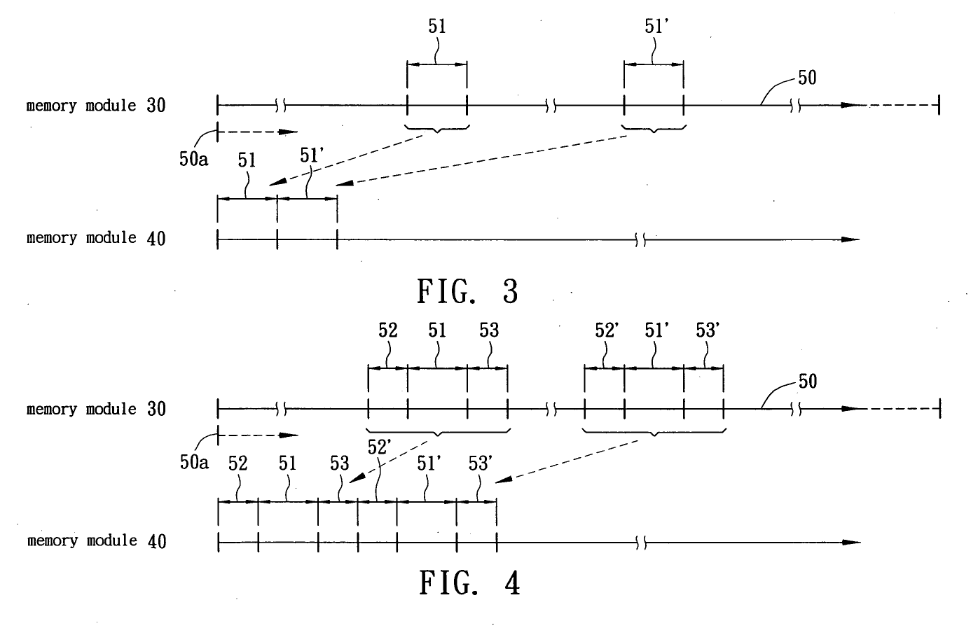

Referring to FIG. 3, the first memory module 30 is used to record real-time audio/video data 50 that is digital audio/video data with continuous attributes. The first memory module 30 rewrites the previous recorded data once the memory recording time reaches a certain corresponding time span to make the memory set full. That means the recording volume of real-time audio/video data overflows the capacity of the first memory module 30. The recording process is automatically renewed from the beginning of the first memory module 30. That means a restart of the recording from the start point 50a of the first memory module 30 and the previous recorded audio/video data being overwritten by new online real-time data.

The second memory module 40 is used to record any accidental events. When important events occur, the second memory module 40 automatically starts to retrieve and record the digital audio/video data of the accidental events 51, 51′ which occurred in different time intervals respectively from the digital audio/video data 50 of the first memory module 30. When being used, the first memory module 30 records real-time audio/video data in a continuous way, and usually with no accidents occurring within the recording time. When accidents happen, due to the short time interval from seconds to minutes of the accidents, the audio/video data of the accidents 51, 51′ only occupy a small portion of the whole record. In the first memory module 30, even if a plurality of accidental events occur, the low capacity audio/video data during the accidents 51, 51′ will not make the second memory module 40 become full quite soon. Thus the second memory module 40 only records small-volume and important audio/video data of the accidents. Therefore, the effect and efficiency of the event data recorder according to the present invention are improved.

Referring to FIG. 4, the second memory module 40 not only retrieves and records digital audio/video data during the accident 51 (or 51′) in FIG. 3 from the real-time audio/video data 50 of the first memory module 30 when accidents occurred, but also retrieves and records pre-alarm audio/video data 52 (or 52′) before the accident and/or post-alarm audio/video data 53 (or 53′) after the accident. The recording time interval of the pre-alarm or the post-alarm audio/video data 52 (or 52′), 53 (or 53′) is able to be set or adjusted into a preset value in advance. For example, the recording time interval is set as a few decades of seconds before and after the accident. Thereby, the audio/video data on accidents 51 (or 51′) in the second memory module 40 retrieved from the first memory module 30 is more complete together with the pre-alarm audio/video data 52 (or 52′) and/or the post-alarm audio/video data 53 (or 53′). Thus the efficiency of the present invention of the Event data recorder (DVR) 10 is enhanced.

The structure and function, the connection together with the storage mechanism between the first memory module 30 and the second memory module 40 and the internal integrated circuit design or software can be achieved by related electronic techniques available now so the detailed description is not mentioned here.

### Second Embodiment

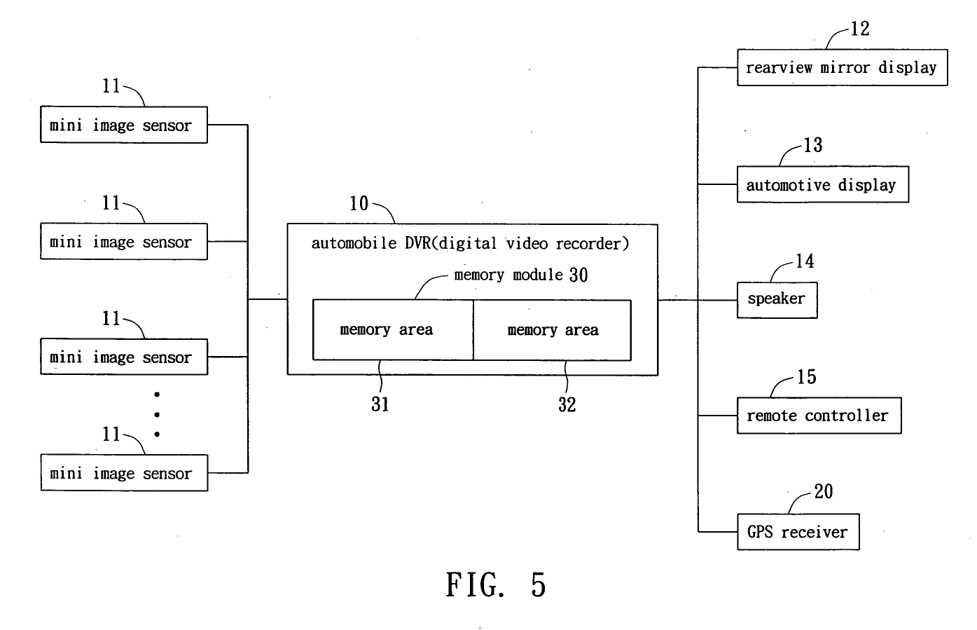

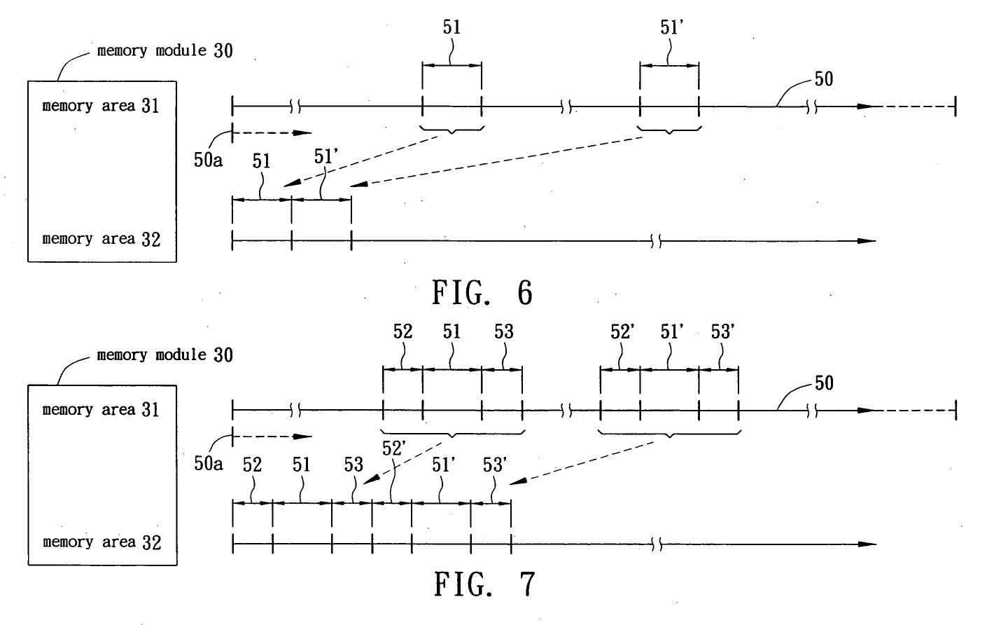

With reference from FIG. 5 to FIG. 7, another embodiment of a car DVR according to the present invention is revealed. The difference between the DVR 10a in FIG. 5 and the DVR 10 in FIG. 2 is that the automobile DVR 10 includes at least a first memory module 30 and a second memory module 40 while the automobile DVR 10a includes only one memory module 30 which is partitioned into at least two memory areas, a first memory area 31 and a second memory area 32. The first memory area 31 and the second memory area 32 respectively replace the first memory module 30 and the second memory module 40 of the car DVR 10a. The first memory area 31 and the second memory area 32 of the memory 30 also have the same storage mechanism as that of the first memory module 30 and the second memory module 40 of the car DVR 10.

Additional advantages and modifications will readily occur to those skilled in the art. Therefore, the invention in its broader aspects is not limited to the specific details and representative devices shown and described herein. Accordingly, various modifications may be made without departing from the spirit or scope of the general inventive concept as defined by the appended claims and their equivalents.

What is claimed is:

1. A storage device of car event data recorders applied to car safety systems with a plurality of audio/video sensors comprising: at least a first memory module and a second memory module; the first memory module is used to record real time audio/video data while the second memory module is for recording audio/video data at the time an event occurred; the second memory module is connected with the first memory module and a storage mechanism is generated by the connection between the first memory module and the second memory module so that during or after an event, the second module starts the recording automatically, and retrieves and records the audio/video data at the time the accident occurred; thereby the storage device of car event data recorders performs long-term safety monitoring by the first memory module and completely records audio/video data at the time each event occurs by aid of the second memory module.

2. The device as claimed in claim 1, wherein when the second memory module retrieves and records the audio/video data at the time of an accident occurs, the second memory module further retrieves pre-alarm audio/video data before the accident and/or post-alarm audio/video data after the accident.

3. The device as claimed in claim 1, wherein the time interval of the pre-alarm or the post-alarm audio/video data is able to be set or adjusted into a preset value in advance.

4. The device as claimed in claim 3, wherein the time interval of the pre-alarm or the post-alarm audio/video data is respectively set as a few decades of seconds before or after the accident.

5. The device as claimed in claim 1, wherein the car safety systems are further connected with car displays, remote controllers, GPS (global positioning system) receivers, or speakers.

6. A storage device of car event data recorders applied to car safety systems with a plurality of audio/video sensors comprising: at least one memory module that is divided into at least two memory areas, a first memory area and a second memory area; the first memory area is used to record real time audio/video data while the second memory area is for recording audio/video data at the time an event occurs; the second memory area is connected with the first memory area and a storage mechanism is generated by the connection between the first memory area and the second memory area so that during or after an event, the second module starts the recording automatically, retrieves and records the audio/video data at the time the accident occurred; thereby the storage device of car event data recorders performs long-term safety monitoring by the first memory area and completely records audio/video data at the time of each event by the aid of the second memory area.

7. The device as claimed in claim 6, wherein when the second memory area retrieves and records the audio/video data at the time an accident occurred, the second memory area further retrieves pre-alarm audio/video data before the accident and/or post-alarm audio/video data after the accident.

8. The device as claimed in claim 7, wherein the time interval of the pre-alarm or the post-alarm audio/video data is able to be set or adjusted into a preset value in advance.

9. The device as claimed in claim 8, wherein the time interval of the pre-alarm or the post-alarm audio/video data is respectively set as a few decades of seconds before or after the accident.

10. The device as claimed in claim 6, wherein the car safety systems are further connected with car displays, remote controllers, GPS (global positioning system) receivers, or speakers.
